(19) United States
(12) Patent Application Publication
(10) Pub. No.: US 2026/0056685 A1
(43) Pub. Date: Feb. 26, 2026

(54) STORAGE MEDIUM STORING PROGRAM FOR CAUSING APPARATUS TO EXECUTE PRINTING, METHOD OF CONTROLLING APPARATUS, INFORMATION PROCESSING APPARATUS, AND IMAGE FORMING APPARATUS

(71) Applicant: CANON KABUSHIKI KAISHA, Tokyo (JP)

(72) Inventor: MASARU ONO, Ibaraki (JP)

(21) Appl. No.: 19/299,737

(22) Filed: Aug. 14, 2025

(30) Foreign Application Priority Data
Aug. 26, 2024 (JP) 2024-144217

(51) Int. Cl. G06F 3/12

(52) U.S. Cl. CPC G06F 3/1208; G06F 3/1205; G06F 3/1252; G06F 3/1256

(57) ABSTRACT

A non-transitory computer-readable storage medium storing a program for causing a computer to execute a method of causing a printing apparatus to execute printing. The program causes an apparatus in which the program has been installed to display an actual-size image for confirming a print result in its actual size, before printing, and causes the apparatus to display a whole image for confirming a whole print result in a state superimposed on the actual-size image, before printing. In the whole image, frame information indicating an area displayed by the actual-size image is included.

### BACKGROUND

### Field of the Technology

The present disclosure relates to a storage medium storing a program for causing an apparatus to execute printing, a method of controlling the apparatus, an information processing apparatus, and an image forming apparatus.

### Description of the Related Art

In a case where an image desired to be printed is displayed on a display device, such as a display of a personal computer (PC) or a liquid crystal display of a smartphone or the like, normally, a pixel density (e.g. 300 ppi (pixel per inch)) of the display device and a printing resolution (e.g. 600 ppi) are different. For this reason, the display size of the image displayed on the display device is different from an actual size of a print result of a printing apparatus. This makes it difficult for a user to confirm the size of a print result, and in a case where fine size adjustment is performed, the user is required to adjust the size by performing printing several times before printing the image. Therefore, it is difficult to confirm the size of a print result before printing the image, and in a case where fine size adjustment is performed, the user is required to adjust the size by performing printing several times. To cope with this, for example, in a technique disclosed in Japanese Laid-Open Patent Publication No. 2001-166763, a resolution of an image to be displayed is calculated, by taking a difference between a pixel density of a display device and a printing resolution into account, whereby an image to be printed is displayed on the display device in the actual size of the print result.

In recent years, as part of activities of supporting a favorite, such as an idol or a character, which are referred to as the “favorite supporting”, goods and the like are often self-made by cutting and pasting an image printed by a printing apparatus. For example, a tin badge using an image printed in accordance with the size of a ready-made frame is made, or lines or the like are printed on paper for decorating figures.

In such use case, it is necessary to adjust the size of an image to be printed such that an image desired to be printed fits to a predetermined frame size. Besides the use case in the “favorite supporting”, there is also a case where a user desires to print e.g. an identification photograph in a specified frame size.

As a method of adjusting the size of an image to be printed, there is a method in which, when creating print data, an image to be printed is displayed on a display device in an actual size of a print result by using the above-described technique disclosed in Japanese Laid-Open Patent Publication No. 2001-166763, and a user adjusts the printing size while confirming the feeling of size on a screen.

However, recently, a smartphone is often used as the display device, and most of the screen sizes of the smartphones are smaller than the size of a print sheet. Therefore, in the above-described method, for example, in a case where an image to be printed in an A4 size is displayed on the smartphone in the actual size of the print result, only a partial area of the image is displayed on the screen of the smartphone. At this time, although a user can confirm the actual size of the print result through the screen of the smartphone, it is difficult for the user to grasp what part of this image is being displayed on the screen.

### SUMMARY

The present disclosure is directed to providing a mechanism that enables a user to grasp, in a case where a print result is displayed on a display device in its actual size, what part of the print result is displayed.

In a first aspect of the present disclosure, there is provided a non-transitory computer-readable storage medium storing a program for causing a computer to execute a method of causing a printing apparatus to execute printing, wherein the method includes causing an apparatus in which the program has been installed to display an actual-size image for confirming a print result in its actual size, before printing, and causing the apparatus in which the program has been installed to display a whole image for confirming a whole print result in a state superimposed on the actual-size image, before printing, wherein in the whole image, frame information indicating an area displayed by the actual-size image is included.

In a second aspect of the present disclosure, there is provided a method of controlling an apparatus in which a program for instructing a printing apparatus to execute printing has been installed, including causing the apparatus in which the program has been installed to display an actual-size image for confirming a print result in its actual size, before printing, and causing the apparatus in which the program has been installed to display a whole image for confirming a whole print result in a state superimposed on the actual-size image, before printing, wherein in the whole image, frame information indicating an area displayed by the actual-size image is included.

Features of the present disclosure will become apparent from the following description of embodiments with reference to the attached drawings. The following description of embodiments are described by way of example.

### BRIEF DESCRIPTION OF THE DRAWINGS

FIG. 1 is a block diagram schematically showing a hardware configuration of an information processing apparatus according to a first embodiment.

FIG. 2 is a block diagram schematically showing a software configuration of the information processing apparatus shown in FIG. 1.

FIG. 3 is a block diagram schematically showing a hardware configuration of a printing apparatus as an image forming apparatus according to the first embodiment.

FIG. 4 is a block diagram schematically showing a software configuration of the printing apparatus shown in FIG. 3.

FIG. 5 is a sequence diagram of a print control process performed by the information processing apparatus and the printing apparatus in the first embodiment.

FIGS. 6A and 6B are diagrams showing examples of actual-size preview screen information and a display image in the first embodiment, respectively.

FIG. 7 is a flowchart of a screen generation process in a step in FIG. 5.

FIG. 8 is a flowchart of an actual-size preview area-drawing process in a step in FIG. 7.

FIG. 9 is a flowchart of a mini map-drawing process in a step in FIG. 7.

FIG. 10 is a flowchart of a screen update process in a step in FIG. 5.

FIGS. 11A to 11E are diagrams each showing an example of a screen displayed on a display device appearing in FIG. 1.

FIGS. 12A and 12B are diagrams useful in explaining changes in a screen in a case where a first operation is performed in the first embodiment.

FIGS. 13A and 13B are diagrams useful in explaining changes in a screen in a case where a second operation is performed in the first embodiment.

FIGS. 14A and 14B are diagrams useful in explaining changes in a screen in a case where a third operation is performed in the first embodiment.

FIG. 15 is a diagram showing a configuration of a printing system in a second embodiment.

FIG. 16 is a sequence diagram of a print control process performed by the information processing apparatus and the printing apparatus in the second embodiment.

FIGS. 17A to 17D are diagrams each showing an example of a screen displayed on the display device appearing in FIG. 3.

FIG. 18 is a diagram showing an example of an actual-size preview screen displayed on the display device in the second embodiment.

FIG. 19 is a flowchart of an actual-size preview area-drawing process performed by the information processing apparatus according to a third embodiment.

FIG. 20 is a diagram showing an example of a display image generated in a step in FIG. 19.

FIGS. 21A to 21E are diagrams each showing an example of a screen displayed on the display device in the third embodiment.

### DESCRIPTION OF THE EMBODIMENTS

The present disclosure will now be described in detail below with reference to the accompanying drawings showing embodiments thereof.

First, a first embodiment of the present disclosure will be described. In the first embodiment, a description will be given of a configuration in which the display of a preview screen of print data is controlled by an information processing apparatus 100.

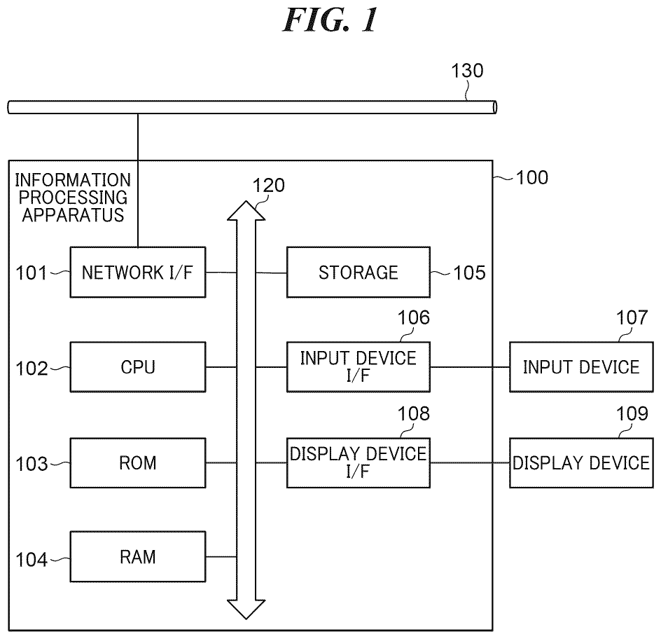

FIG. 1 is a block diagram schematically showing a hardware configuration of the information processing apparatus 100 according to the present embodiment. Referring to FIG. 1, the information processing apparatus 100 includes a network interface (I/F) 101, a central processing unit (CPU) 102, a read only memory (ROM) 103, a random access memory (RAM) 104, a storage 105, an input device I/F 106, and a display device I/F 108. These components are capable of transmitting and receiving data to and from each other via a system bus 120.

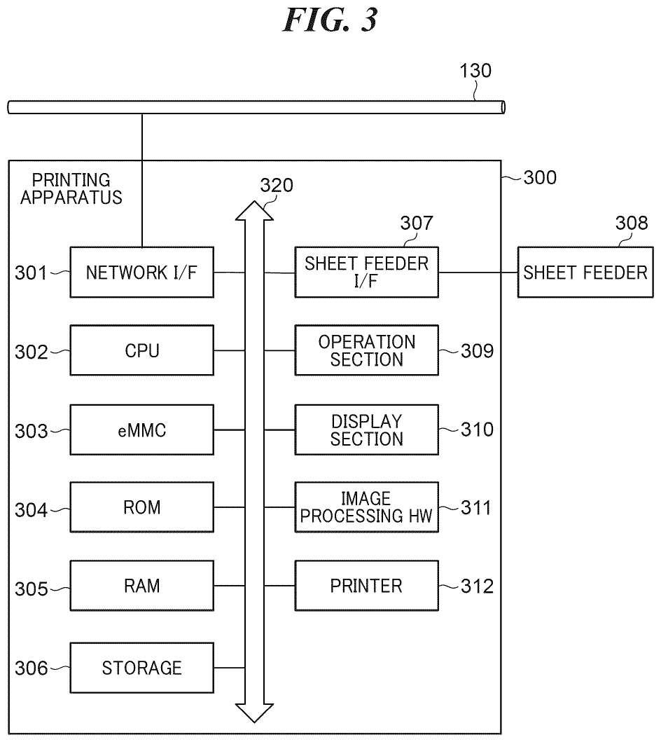

The network I/F 101 transmits and receives a variety of data to and from a printing apparatus 300, described hereinafter with reference to FIG. 3, via a network 130, such as a wide area network (WAN) or a local area network (LAN).

The CPU 102 is a controller for controlling the overall operation of the information processing apparatus 100. The CPU 102 starts an operating system (OS) according to a boot program stored in the ROM 103 as a nonvolatile memory. The CPU 102 controls the information processing apparatus 100 by executing control programs recorded in the storage 105, on the OS. The RAM 104 functions as a temporary storage area, such as a main memory and a work area for the CPU 102. The storage 105 is a writable/readable nonvolatile memory, such as a hard disk drive (HDD) or a solid state drive (SSD), and stores the above-mentioned control programs and so forth.

The input device I/F 106 is an interface for connecting to an input device 107. The input device 107 is a device used by a user to input e.g. an instruction to the information processing apparatus 100, such as a mouse and a keyboard. The display device I/F 108 is an interface for connecting a display device 109 to the information processing apparatus 100. The display device 109 is e.g. a liquid crystal display and is a device for notifying information to a user from a screen of the information processing apparatus 100. Note that the configuration can be such that a smartphone or a PC includes the information processing apparatus 100 and the display device 109. Further, in a case where the display device 109 is a component of a smartphone or a PC, the display device 109 also function as the input device 107 by a touch operation thereon.

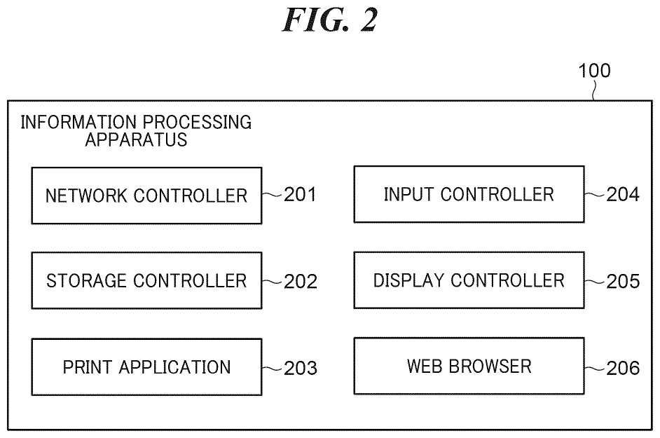

FIG. 2 is a block diagram schematically showing a software configuration of the information processing apparatus 100 shown in FIG. 1. Referring to FIG. 2, the information processing apparatus 100 functions by software as a network controller 201, a storage controller 202, a print application 203, an input controller 204, a display controller 205, and a Web browser 206. The functions of the software are realized by the CPU 102 executing programs loaded into the RAM 104.

The network controller 201 has a function of controlling communication with the network 130 via the network I/F 101 to transmit and receive a variety of data to and from an external apparatus. For example, the information processing apparatus 100 is capable of communicating information, such as print data, with the printing apparatus 300 via the network 130. The storage controller 202 controls the storage 105 and has a function of reading and writing data.

The print application 203 is an application for instructing execution of printing e.g. to the printing apparatus 300. The print application 203 has a function of transmitting print data selected by a user to the printing apparatus 300 via the network I/F 101. Further, the user can perform operations for making print settings, editing an image to be printed, displaying an actual-size preview, and so forth, via the print application 203.

The input controller 204 controls the input device 107 via the input device I/F 106 and has a function of receiving data input by a user and operating each controller based on received data. The display controller 205 has a function of performing control to display a variety of screens on the display device 109 connected via the display device I/F 108. The Web browser 206 is software used by the information processing apparatus 100 for connecting to a Web server, and has functions of transmitting and receiving data mainly by using Hyper Text Transfer Protocol (HTTP) communication, and displaying a Web page.

FIG. 3 is a block diagram schematically showing a hardware configuration of the printing apparatus 300 as an image forming apparatus according to the present embodiment.

The printing apparatus 300 includes a network I/F 301, a CPU 302, an embedded Multi Media Card (eMMC) 303, a ROM 304, a RAM 305, a storage 306, a sheet feeder I/F 307, an operation section 309, a display section 310, an image processing hardware module (HW) 311, and a printer 312. These components are capable of transmitting and receiving data to and from each other via a system bus 320.

The network I/F 301 transmits and receives print data to and from an external apparatus, such as the information processing apparatus 100, via the network 130, such as a wide area network (WAN) or a local area network (LAN).

The CPU 302 is a controller for controlling the overall operation of the printing apparatus 300. The CPU 302 starts an OS by a boot program stored in the ROM 304 as a nonvolatile memory. The CPU 302 controls the printing apparatus 300 by executing controller programs recorded in the storage 306, on the OS. The eMMC 303 is implemented by a flash memory and stores the control programs and the like for the CPU 302. The RAM 305 functions as a temporary storage area, such as a main memory and a work area for the CPU 302. The storage 306 is a writable/readable nonvolatile memory and stores the above-mentioned controller programs and the like.

The sheet feeder I/F 307 is an interface for connecting a sheet feeder 308 to the printing apparatus 300. The sheet feeder 308 is a device connected to the printing apparatus 300, for feeding sheets necessary for printing, one by one. The operation section 309 includes keys used by a user to perform a variety of operations, a screen displaying information in the device, and so forth. The display section 310 is implemented e.g. by a liquid crystal display, for notifying information to a user by displaying a screen thereon. Note that the configuration can be such that the operation section 309 and the display section 310 are formed as an integrated device, such as a touch panel.

The image processing HW 311 is a hardware module that performs image processing within the printing apparatus 300, such as processing for decoding print data, processing for adding a margin, and enlargement/reduction processing. The printer 312 is a device that prints an image based on print data by applying a recording material, such as toner or ink, onto a sheet (recording sheet) fed from the sheet feeder 308 and fixing the recording material to the sheet.

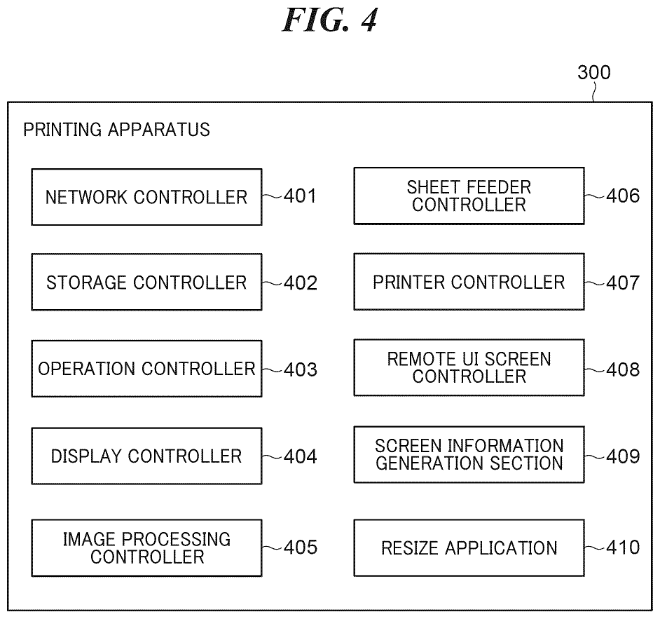

FIG. 4 is a block diagram schematically showing a software configuration of the printing apparatus 300 shown in FIG. 3. Referring to FIG. 4, the printing apparatus 300 functions by software as a network controller 401, a storage controller 402, an operation controller 403, a display controller 404, an image processing controller 405, and a sheet feeder controller 406. The printing apparatus 300 further functions by software as a printer controller 407, a remote user interface (UI) screen controller 408, a screen information generation section 409, and a resize application 410. The functions of the software are realized by the CPU 302 executing programs loaded into the RAM 305.

The network controller 401 has a function of controlling communication with the network 130 via the network I/F 301 to transmit and receive a variety of data to and from an external apparatus. The storage controller 402 controls the storage 306 and has a function of reading and writing data. The operation controller 403 controls the operation section 309 and has a function of acquiring input information from a user. The display controller 404 has a function of displaying a screen. The display controller 404 controls the display section 310 to generate screen data to be displayed on the display section 310.

The image processing controller 405 controls the image processing HW 311 and has a function of performing image processing, such as enlargement/reduction, on print data received by the printing apparatus 300. The sheet feeder controller 406 controls the sheet feeder 308 via the sheet feeder I/F 307 and has a function of feeding sheets necessary for printing. The printer controller 407 controls the printer 312 and has a function of performing printing by fixing a recording material, such as toner or ink, applied on each sheet.

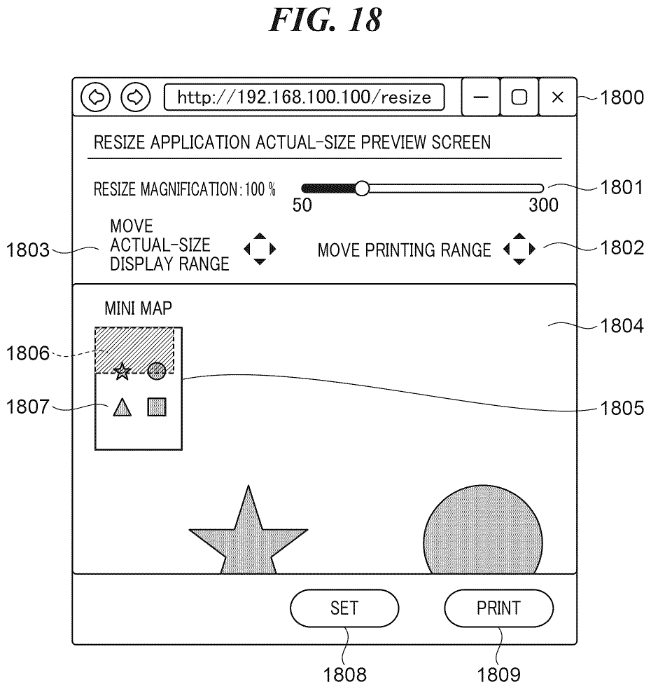

The remote UI screen controller 408 has a function of controlling the screen of the Web browser 206 by providing screen information generated by the screen information generation section 409 to the Web browser 206 by communication according to the HTTP. The screen information generation section 409 has a function of generating the screen information of e.g. the Hyper Text Markup Language (HTML) format, which is to be displayed on the Web browser 206. The resize application 410 is an application for instructing execution of printing from an external apparatus to the printing apparatus 300 via the remote UI. The resize application 410 has a screen information generation function for displaying an actual-size preview screen 1800, described hereinafter with reference to FIG. 18, on the display device 109 of the information processing apparatus 100 to which print data is input, via the remote UI. On the actual-size preview screen 1800, described hereinafter, the user can adjust a printing size, provide a print instruction, and so forth. Note that details of the resize application 410 will be described hereinafter in a second embodiment.

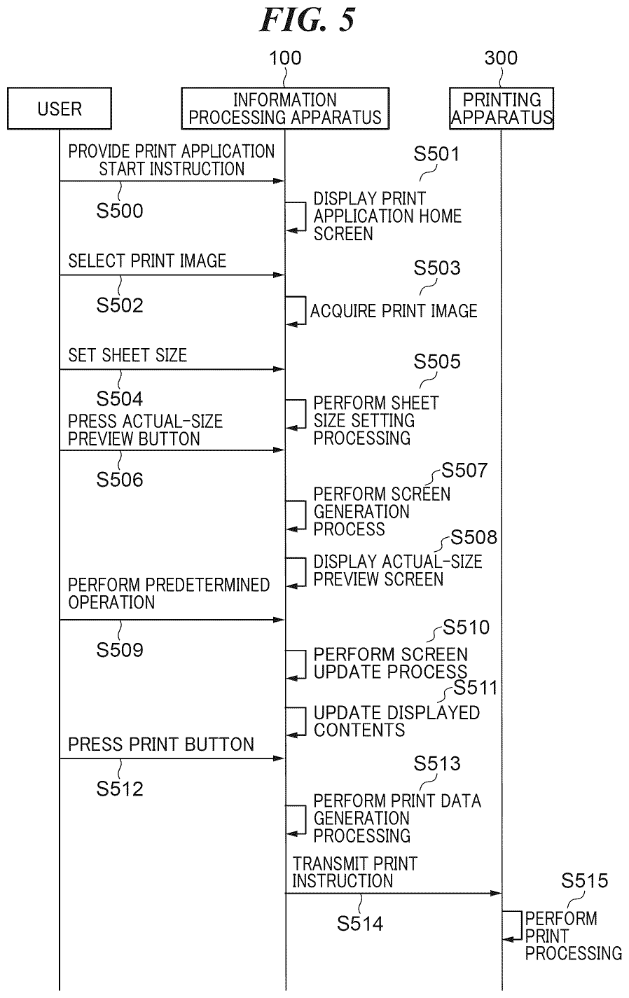

FIG. 5 is a sequence diagram of a print control process performed by the information processing apparatus 100 and the printing apparatus 300 in the present embodiment. Note that processing operations performed by the information processing apparatus 100 are realized by the CPU 102 executing a program loaded e.g. from the ROM 103 into the RAM 104. Processing operations performed by the printing apparatus 300 are realized by the CPU 302 executing a program loaded e.g. from the ROM 304 into the RAM 305.

Referring to FIG. 5, first, the user provides an instruction for starting the print application 203 installed in the information processing apparatus 100 (S500).

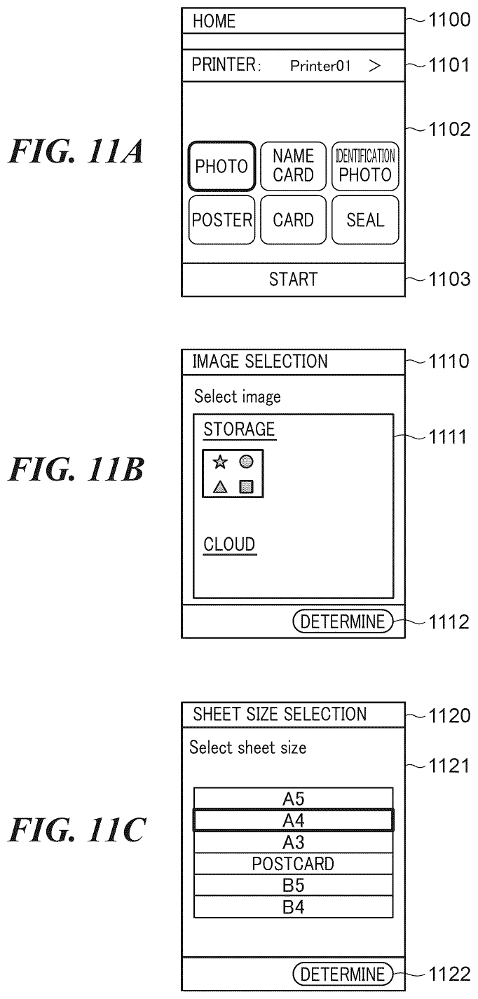

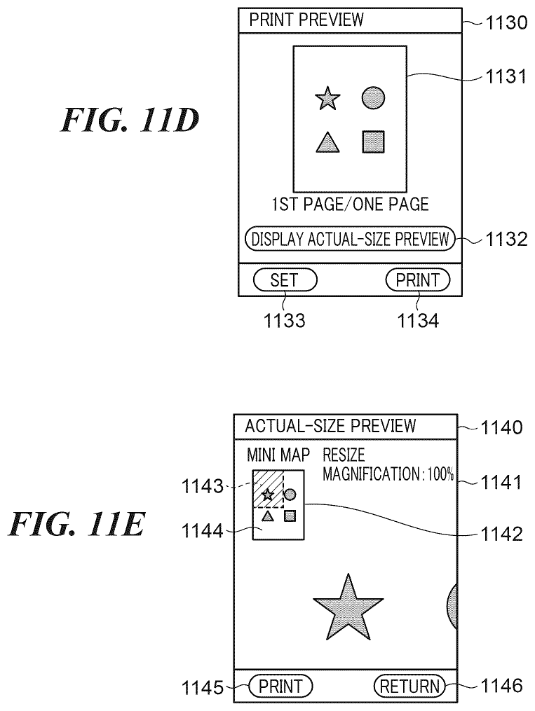

Then, the information processing apparatus 100 starts the print application 203 according to the start instruction. With this, the following processing operations of the information processing apparatus 100 are performed by the print application 203. Further, the information processing apparatus 100 displays a print application home screen 1100 shown in FIG. 11A on the display device 109 (S501).

Referring to FIG. 11A, the print application home screen 1100 is composed of a printing apparatus selection area 1101, an icon area 1102, a start button 1103, and so forth. By pressing the printing apparatus selection area 1101, the user can set a printing apparatus which is caused to execute print processing. Further, by selecting an icon corresponding to a print use from the icon area 1102 and pressing the start button 1103, the user can cause the print application 203 to start a print operation. For example, when the user presses the start button 1103 in a state in which “photo” is selected in the icon area 1102, the screen on the display device 109 is switched to an image selection screen 1110 shown in FIG. 11B.

Referring to FIG. 11B, the image selection screen 1110 is a screen for selecting image data to be printed (hereinafter referred to as the “print image”) and is composed of an image selection area 1111, a determine button 1112, and so forth. The user can select a print image from the image selection area 1111. In the image selection area 1111, a list of image data stored in the storage 105 of the information processing apparatus 100, a cloud storage registered in advance, or the like, is displayed.

Referring again to FIG. 5, the user selects a print image from the image data displayed in the image selection area 1111 on the image selection screen 1110 (S502).

When the user presses the determine button 1112 in a state in which the print image is selected, the information processing apparatus 100 acquires the selected print image (S503). Further, the information processing apparatus 100 switches the screen on the display device 109 to a sheet size selection screen 1120 shown in FIG. 11C. The sheet size selection screen 1120 is composed of a sheet selection area 1121, a determine button 1122, and so forth.

Then, the user sets a sheet size to be used in the print processing (S504). Note that in the present embodiment, the user can set a sheet size to be used in the print processing, by pressing the determine button 1122 in a state in which one sheet size is selected from a list of sheet sizes displayed in the sheet selection area 1121.

When the user sets the sheet size in the step S504, the information processing apparatus 100 performs sheet size setting processing (S505). In the sheet size setting processing, as print setting information set when printing is performed, the sheet size set in the step S504 is set. Further, the information processing apparatus 100 switches the screen on the display device 109 to a print preview screen 1130 shown in FIG. 11D.

Referring to FIG. 11D, the print preview screen 1130 is composed of a print preview area 1131, an actual-size preview display button 1132, a setting button 1133, a print button 1134, and so forth. In the print preview area 1131, the whole print image laid out for printing is displayed. The actual-size preview display button 1132 is a button for instructing display of an actual-size preview screen 1140 shown in FIG. 11E. The setting button 1133 is a button for changing print settings including a setting of monochrome/color and a setting of image correction. The print button 1134 is a button for transmitting a print instruction from the information processing apparatus 100 to the printing apparatus 300.

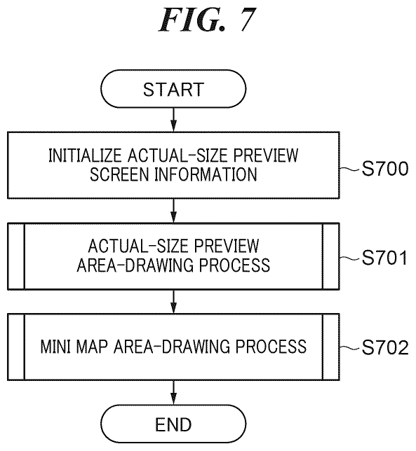

Referring again to FIG. 5, when the user presses the actual-size preview display button 1132 (S506), the information processing apparatus 100 performs a screen generation process for displaying the actual-size preview screen 1140 (S507). Note that details of the screen generation process will be described hereinafter with reference to FIG. 7. Then, the information processing apparatus 100 displays the actual-size preview screen 1140 shown in FIG. 11E on the display device 109 (S508).

Referring to FIG. 11E, the actual-size preview screen 1140 is composed of an actual-size preview area 1141, a mini map area 1142, a return button 1145, a print button 1146, and so forth.

In the actual-size preview area 1141, an image is displayed which is generated by converting a print result to be obtained when a print image is printed on a designated sheet to an actual size. The displayed image is an image for confirming a print result in its actual size before printing, and the image is hereinafter referred to as the “actual-size image”. The user can intuitively confirm the feeling of size of the print result before printing, by confirming the actual-size image displayed in the actual-size preview area 1141.

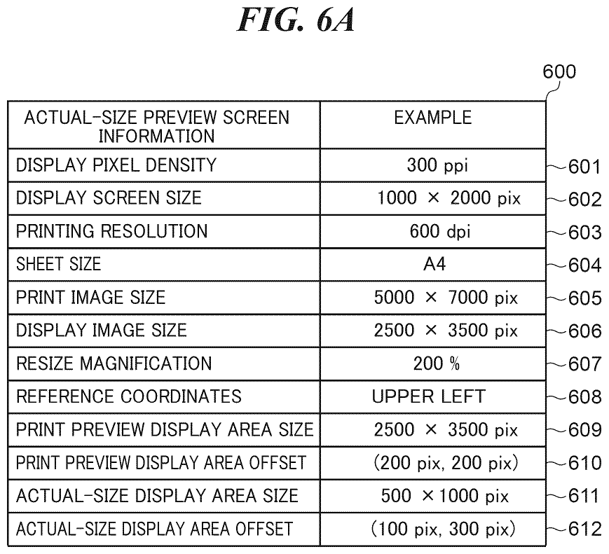

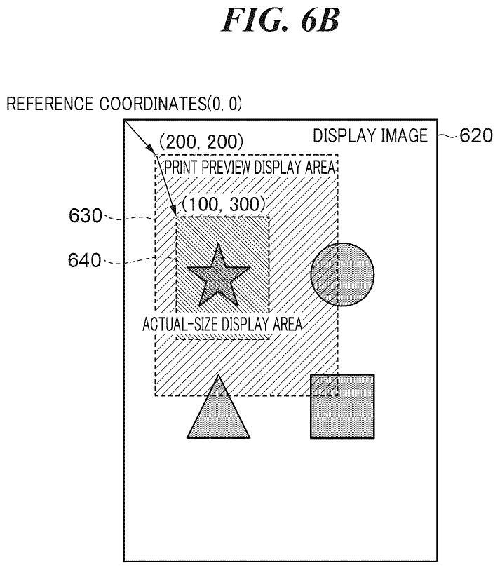

The mini map area 1142 is comprised of an actual-size display area 1143 and a print preview display area 1144. In the print preview display area 1144, an image generated by reducing the whole area to be printed, of a display image 620 shown in FIG. 6B, which is generated in the step S507, at a certain ratio is displayed. This image is an image (whole image) for confirming the whole print result before printing, and is a preview image showing a state in which the print image is printed on a designated sheet. Note that the display image 620 is an image generated by converting the image size of the print image in accordance with the pixel density of the screen of the display device 109. In the actual-size display area 1143, frame information indicating an area displayed in the actual-size image in the display image 620, specifically, an actual-size display area 640, descried hereinafter, is displayed as a hatched area reduced at the same ratio of the print preview display area 630, in a state superimposed on the print preview display area 1144. The user can perform size adjustment of the print image and the like by performing a predetermined operation on the actual-size preview area 1141.

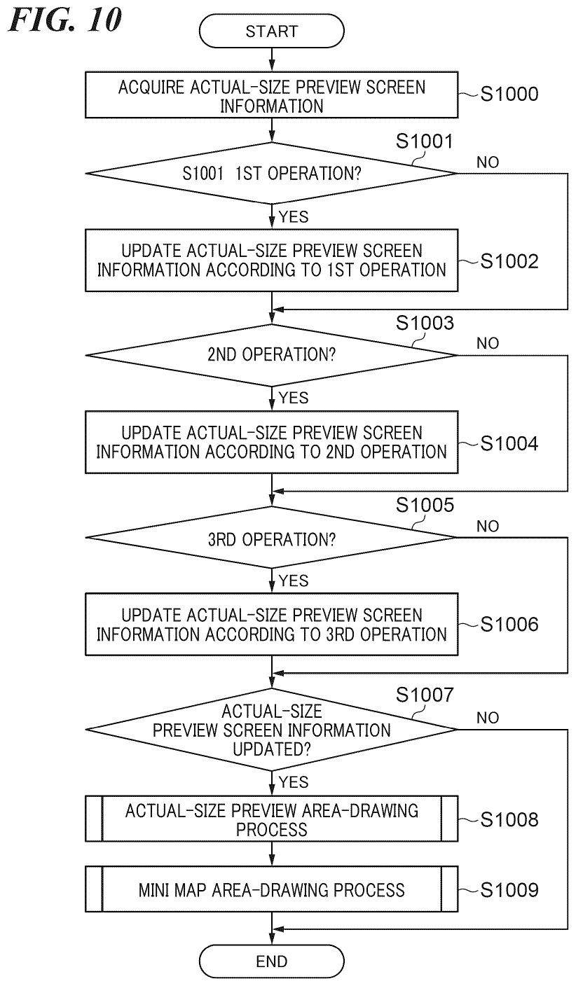

Referring again to FIG. 5, when the user performs a predetermined operation with respect to the actual-size preview area 1141 (S509), the information processing apparatus 100 performs a screen update process in response to this operation (S510). Note that details of the screen update process will be described hereinafter with reference to FIG. 10. For example, in the screen update process, enlargement/reduction of the print image and update of actual-size preview screen information 600, shown in FIG. 6A, for generating the actual-size preview screen 1140, are performed. Then, the information processing apparatus 100 updates the displayed content on the actual-size preview screen 1140 (S511).

Then, when the user presses the print button 1146 on the actual-size preview screen 1140 (S512), the information processing apparatus 100 performs print data generation processing (S513). In the print data generation processing, the information processing apparatus 100 generates print data for printing the image in the range indicated by the print preview display area 630. For example, in a case where a resize magnification 607 of the actual-size preview screen information 600 is changed in the step S510, in the print data generation processing, the print data is generated based on the print image enlarged/reduced according to the changed resize magnification 607. After that, the information processing apparatus 100 transmits an instruction for printing the generated print data to the printing apparatus 300 (S514).

The printing apparatus 300 performs the print processing according to the print instruction received from the information processing apparatus 100 (S515). After that, the print control process performed by the information processing apparatus 100 and the printing apparatus 300 is terminated.

FIGS. 6A and 6B are diagrams showing examples of the actual-size preview screen information 600 and the display image 620 in the present embodiment, respectively.

FIG. 6A shows the actual-size preview screen information 600 for generating the actual-size preview screen 1140. The actual-size preview screen information 600 includes a display pixel density 601, a display screen size 602, a printing resolution 603, a sheet size 604, a print image size 605, and a display image size 606. The actual-size preview screen information 600 further includes the resize magnification 607, reference coordinates 608, a print preview display area size 609, a print preview display area offset 610, an actual-size display area size 611, and an actual-size display area offset 612. The actual-size preview information 600 is stored e.g. in the ROM 103 or the storage 105.

The display pixel density 601 and the display screen size 602 are the pixel density (unit: ppi) and the screen size (unit: pixel) of the screen displayed on the display device 109, respectively.

The printing resolution 603, the sheet size 604, and the print image size 605 are settings managed by the print application 203 as the print settings. The print image size 605 can be calculated as the product of the printing resolution 603 (unit:dpi) and the sheet size 604 (unit:inch).

The display image size 606 is the size of the display image 620, which is a size to which the print image size 605 is converted according to a ratio of the printing resolution 603 and the display pixel density 601 so as to display a print result in its actual size on the display device 109.

The resize magnification 607 is a magnification ratio and a reduction ratio of print data. When a print result in its actual size is displayed on the actual-size preview screen 1140, a print result enlarged or reduced by the resize magnification 607 is displayed.

The reference coordinates 608 are coordinates used as a reference on the display image 620, for enlargement or reduction when the print result is enlarged or reduced on the actual-size preview screen 1140. The information processing apparatus 100 performs enlargement processing and reduction processing by fixing the reference coordinates 608. In the present embodiment, coordinates of an upper left corner of the display image 620 will be described as the reference coordinates 608, by way of example. Note that the reference coordinates 608 can be set to desired coordinates, such as the center or a lower right corner of the display image 620, or the center point of the screen operation.

The print preview display area size 609 is a size (unit: pixel) of an area in the display image 620, displayed in the print preview display area 1144 of the mini map area 1142. The print preview display area size 609 is changed according to the resize magnification 607 and is obtained by dividing the print image size 605 by a value of the resize magnification 607.

The print preview display area offset 610 is a value for designating a position of the print preview display area 630, appearing in FIG. 6B, relative to the reference coordinates 608 of the display image 620.

The actual-size display area size 611 is a size (unit: pixel) of an area in the display image 620, which is displayed in the actual-size preview area 1141. The actual-size display area size 611 is changed according to the resize magnification 607 and obtained by dividing the display screen size 602 by the resize magnification 607.

The actual-size display area offset 612 is a value for designating a position of the actual-size display area 640, relative to the reference coordinates 608 of the print preview display area 630 appearing in FIG. 6B. Note that the reference for designating a relative position can be set to the reference coordinates 608 of the print image.

FIG. 6B is a diagram showing an example of the display area of the print image displayed in the actual-size preview area 1141 and the mini map area 1142 on the actual-size preview screen 1140.

The print image is image information of print data, which is print data selected in the step S502. For example, when printing is executed in a state in which the resize magnification 607 is set to 100%, the whole area of the print image is directly printed on a print sheet.

The display image 620 is generated based on the print image selected in the step S502 in the screen generation process in the step S507. The display image 620 is an image converted in image size in accordance with the display pixel density 601 so as to display the print image generated with reference to the printing resolution 603, on the display device 109.

The print preview display area 630 is an area in the display image 620, displayed in the print preview display area 1144 of the mini map area 1142. The print preview display area 630 is uniquely determined by the print preview display area size 609 and the print preview display area offset 610.

The actual-size display area 640 is an area in the display image 620, which is displayed in the actual-size preview area 1141. The actual-size display area 640 is determined by the actual-size display area size 611 and the actual-size display area offset 612. The actual-size display area 640 is displayed as the actual-size display area 1143 of the mini map area 1142 so as to enable a user to intuitively understand what part of the print image is displayed in the actual-size preview area 1141.

FIG. 7 is a flowchart of the screen generation process performed in the step S507 in FIG. 5. The screen generation process is realized by the CPU 102 of the information processing apparatus 100, executing a program loaded into the RAM 104.

Referring to FIG. 7, first, the CPU 102 initializes the actual-size preview screen information 600 (S700). Specifically, the CPU 102 acquires the pixel density and the screen size of the display device 109 and sets the acquired values to the display pixel density 601 and the display screen size 602, respectively. Note that as the method of acquiring the pixel density and the screen size of the display device 109, an existing method can be used. Further, the values of the printing resolution 603, the sheet size 604, and the print image size 605 are set with reference to the print settings of the print application 203. Further, the values of the resize magnification 607, the reference coordinates 608, the print preview display area size 609, the print preview display area offset 610, the actual-size display area size 611, and the actual-size display area offset 612 are set to default values, such as “0”, as the initial values.

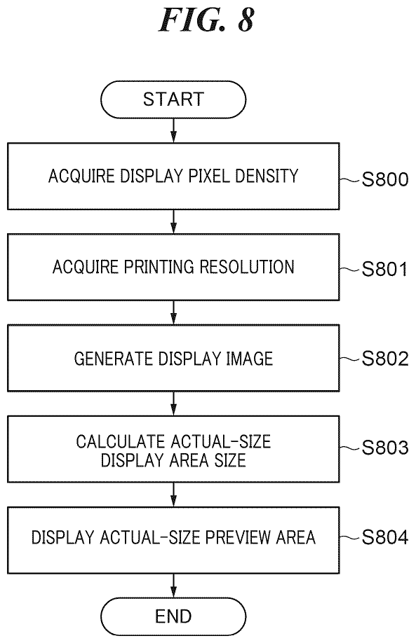

Then, the CPU 102 performs a process for drawing the actual-size preview area 1141, which is described hereinafter with reference to FIG. 8 (S701).

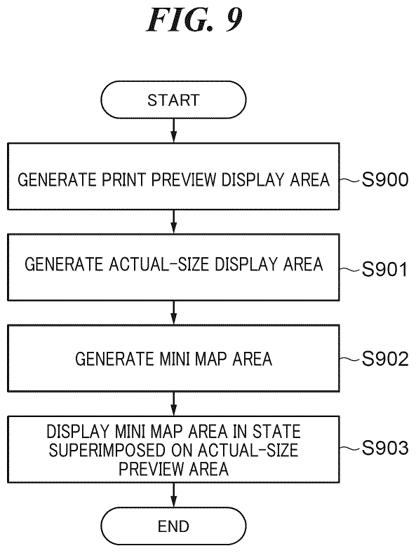

Then, the CPU 102 performs a process for drawing the mini map area 1142, described hereinafter with reference to FIG. 9 (S702). After that, the present process is terminated. By executing the above-described screen generation process, the actual-size preview screen 1140 is generated.

FIG. 8 is a flowchart of the process for drawing the actual-size preview area 1141 in the step S701 in FIG. 7.

Referring to FIG. 8, the CPU 102 acquires the values of the display pixel density 601 and the printing resolution 603 of the display device 109 from the actual-size preview screen information 600 (S800 and S801).

Then, the CPU 102 generates the display image 620 for displaying a print result in its actual size in the actual-size preview area 1141 (S802). The display image 620 is, as described above, an image converted in image size in accordance with the display pixel density 601 so as to display the print image generated with reference to the printing resolution 603 on the display device 109.

Then, the CPU 102 calculates the actual-size display area size 611 set for displaying the print result in its actual size on the display device 109 (S803). Specifically, the size of the actual-size preview area 1141 displayed on the display device 109 becomes the actual-size display area size 611, and in a case where the actual-size preview area 1141 is displayed on the whole area of the screen of the display device 109, the value of the actual-size display area size 611 becomes equal to the value of the display screen size 602.

Then, the CPU 102 displays the actual-size display area 640 in the display image 620 generated in the step S802, which is determined by the actual-size display area size 611 and the actual-size display area offset 612, in the actual-size preview area 1141 (S804). After that, the present process is terminated.

FIG. 9 is a flowchart of the process for drawing the mini map area 1142 in the step S702 in FIG. 7.

Referring to FIG. 9, the CPU 102 generates the print preview display area 630 to be displayed as the print preview display area 1144 (S900). The print preview display area 630 is an area actually printed on a print sheet when printing is executed, and is generated by extracting an area determined by the print preview display area size 609 and the print preview display area offset 610, from the display image 620.

Then, the CPU 102 generates the actual-size display area 640 (S901). The actual-size display area 640 is an area displayed in the actual-size preview area 1141, out of the display image 620, and is determined by the actual-size display area size 611 and the actual-size display area offset 612.

Then, the CPU 102 generates the mini map area 1142 by arranging the frame of the actual-size display area 1143 generated in the step S901 in a state superimposed on the image of the print preview display area 630 generated in the step S900 (S902).

Then, the CPU 102 displays the mini map area 1142 generated in the step S902 in a state superimposed on the actual-size preview area 1141 (S903). Then, the present process is terminated. Note that the position and the size of the mini map area 1142 are not limited, and the position and the size can be properly changed when displayed in the step S903 such that the user can easily visually recognize the image of the actual-size preview area 1141.

FIG. 10 is a flowchart of the screen update process in the step S510 in FIG. 5. The screen update process is realized by the CPU 102 of the information processing apparatus 100, executing a program loaded into the RAM 104. The screen update process is started when the user performs a predetermined operation on the actual-size preview area 1141 (S509).

Referring to FIG. 10, first, the CPU 102 acquires the current values of the actual-size preview screen information 600 (S1000). Then, the CPU 102 determines whether or not the predetermined operation received from the user is a first operation (S1001). The first operation is an operation for reducing or enlarging an image displayed in the actual-size preview area 1141, such as a pinch-in or pinch-out operation. If it is determined that the predetermined operation is not the first operation, the present process proceeds to a step S1003, described hereinafter. If it is determined that the predetermined operation is the first operation, the present process proceeds to a step S1002.

In the step S1002, the CPU 102 updates the actual-size preview screen information 600 according to an operation amount of the first operation. Specifically, the CPU 102 updates the value of the resize magnification 607 of the actual-size preview screen information 600 according to the operation amount of the first operation. Further, the CPU 102 also updates the values of the print preview display area size 609 and the actual-size display area size 611, which are in corresponding relationship to the resize magnification 607.

Then, the CPU 102 determines whether or not the predetermined operation received from the user is a second operation (S1003). The second operation is an operation for changing the display range of the image displayed in the actual-size preview area 1141, such as a swipe operation with one finger. If it is determined that the predetermined operation is not the second operation, the present process proceeds to a step S1005, described hereinafter. If it is determined that the predetermined operation is the second operation, the present process proceeds to a step S1004.

In the step S1004, the CPU 102 updates the actual-size preview screen information 600 according to an operation amount of the second operation. Specifically, the CPU 102 updates the value of the actual-size display area offset 612 of the actual-size preview screen information 600 according to the operation amount of the second operation.

Then, the CPU 102 determines whether or not the predetermined operation received from the user is a third operation (S1005). The third operation is an operation for changing the display range of the print preview displayed in the mini map area 1142, i.e. the printing range, such as a swipe operation with two fingers. If it is determined that the predetermined operation is not the third operation, the present process proceeds to a step S1007, described hereinafter. If it is determined that the predetermined operation is the third operation, the present process proceeds to a step S1006.

In the step S1006, the CPU 102 updates the actual-size preview screen information 600 according to an operation amount of the third operation. Specifically, the CPU 102 updates the value of the preview display area size 609 of the actual-size preview screen information 600 according to the operation amount of the third operation.

Then, the CPU 102 determines whether or not the actual-size preview screen information 600 has been updated by a user's operation (S1007). If it is determined that the actual-size preview screen information 600 has not been updated by a user's operation, the present process is terminated. If it is determined that the actual-size preview screen information 600 has been updated by a user's operation, the present process proceeds to a step S1008.

In the step S1008, the CPU 102 performs the above-described actual-size preview area-drawing process. Then, the CPU 102 performs the above-described process for drawing the mini map area 1142 (S1009). Thus, the actual-size preview screen 1140 is updated based on the actual-size preview screen information 600 updated in the step S1002, S1004, and/or S1006. Then, the present process is terminated.

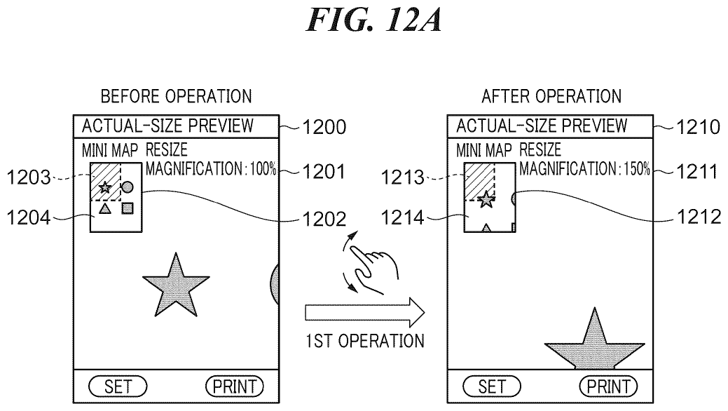

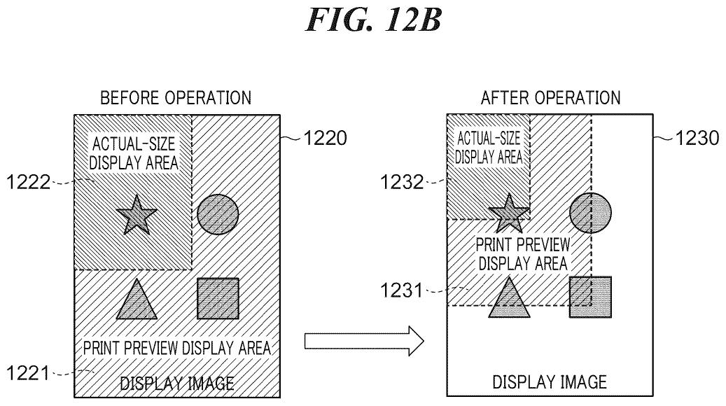

FIGS. 12A and 12B are diagrams useful in explaining changes in the screen in a case where the first operation is performed in the present embodiment. FIG. 12A shows a change in the actual-size preview screen before and

after the first operation. Further, FIG. 12B shows changes in the print preview display area and the actual-size display area before and after the first operation. The resize magnification 607 of the actual-size preview screen information 600 is updated by the first operation. With this update, the size of an image displayed in an actual-size preview area 1201 on an actual-size preview screen 1200 shown in FIG. 12A, and the size of an image displayed in a print preview display area 1204 in a mini map area 1202 shown in FIG. 12A are changed. For example, in an actual-size preview area 1211 on an actual-size preview screen 1210 after the first operation has been performed, an image enlarged based on the resize magnification 607 updated by the first operation is displayed. Further, in a print preview display area 1214 in a mini map area 1212 after the first operation has been performed, an image enlarged based on the resize magnification 607 updated by the first operation is also displayed. Note that the sizes of a print preview display area 1221 and an actual-size display area 1222 in a display image 1220 shown in FIG. 2B are both changed inversely proportionally to the resize magnification 607, as shown in a print preview display area 1231 and an actual-size display area 1232 in a display image 1230 after the first operation. Therefore, the size of the actual-size display area 1222, relative to the print preview display area 1221, is not changed even when the resize magnification 607 is updated by the first operation. In other words, the size of an actual-size display area 1203 in the mini map area 1202 before the first operation is performed, and the size of an actual-size display area 1213 in the mini map area 1212 after the first operation is performed are the same.

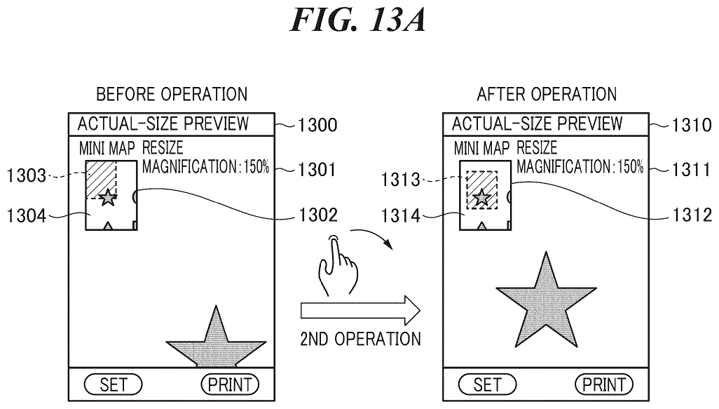

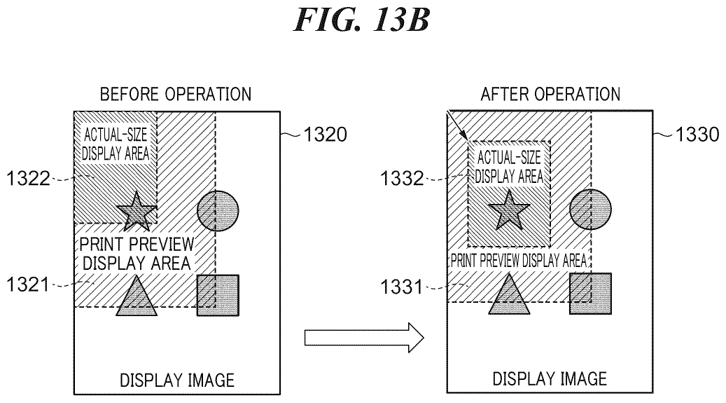

FIGS. 13A and 13B are diagrams useful in explaining changes in the screen in a case where the second operation is performed in the present embodiment.

FIG. 13A shows a change in the actual-size preview screen before and after the second operation. Further, FIG. 13B shows changes in the print preview display area and the actual-size display area before and after the second operation.

When the actual-size display area offset 612 of the actual-size preview screen information 600 is updated by the second operation, the position of an actual-size preview area 1303 in a mini map area 1302 in an actual-size preview area 1301 on an actual-size preview screen 1300 before the second operation is changed, with reference to the reference coordinates 608, as shown in FIG. 13A, to the position of an actual-size preview area 1313 in a mini map area 1312 in an actual-size preview area 1311 on an actual-size preview screen 1310 after the second operation. In other words, as shown in FIG. 13B, the position of an actual-size display area 1322 in a print preview display area 1321 in a display image 1320 is changed to the position of an actual-size display area 1332 in a print preview display area 1331 in a display image 1330. As a result, the display range of the image displayed in the actual-size preview area 1301 on the actual-size preview screen 1300 in FIG. 13A is changed. With this, a star-shaped object is displayed in substantially the center. Note that even after the second operation is performed, the position and the size of the print preview display area 1321 are not changed. Therefore, an image displayed in a print preview display area 1314 in a mini map area 1312 after the second operation is the same as an image displayed in a print preview display area 1304 in the mini map area 1302 before the second operation. Further, the size of the actual-size display area 1313 in the mini map area 1312 after the second operation is the same as the size of the actual-size display area 1303 in the mini map area 1302 before the second operation.

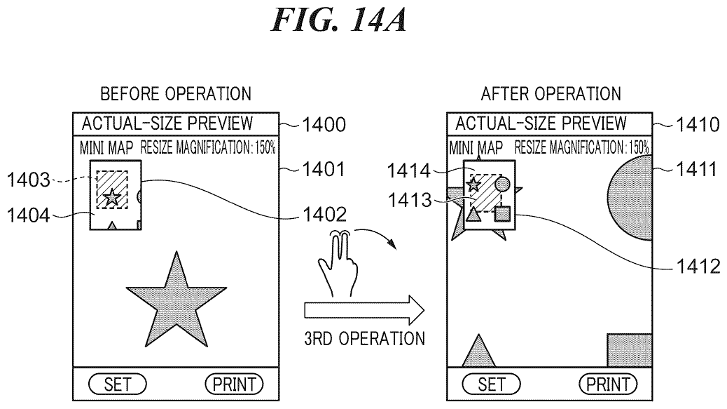

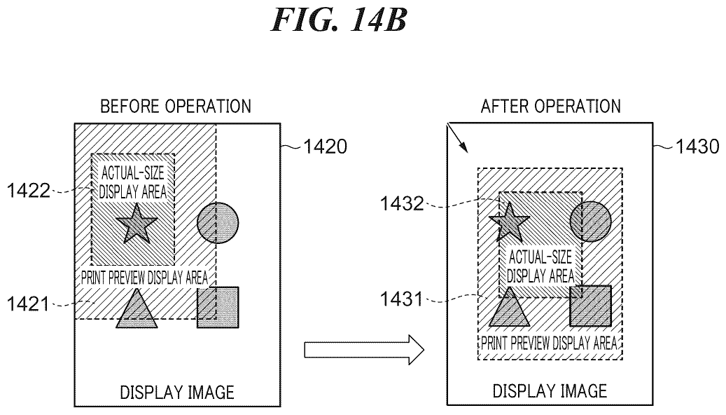

FIGS. 14A and 14B are diagrams useful in explaining changes in the screen in a case where the third operation is performed in the present embodiment.

FIG. 14A shows a change in the actual-size preview screen before and after the third operation. Further, FIG. 14B shows changes in the print preview display area and the actual-size display area before and after the third operation. The print preview display area offset 610 of the actual-size preview screen information 600 is updated by the third operation. With this update, with reference to the reference coordinates 608, as shown in FIG. 14A, the position of an actual-size preview area 1403 in a mini map area 1402 in an actual-size preview area 1401 on an actual-size preview screen 1400 before the third operation is changed to the position of an actual-size preview area 1413 in a mini map area 1412 in an actual-size preview area 1411 on an actual-size preview screen 1410 after the third operation. Further, the display range of an image displayed in a print preview display area 1404 on the actual-size preview screen 1400 is changed to the display range of an image displayed in a print preview display area 1414 on the actual-size preview screen 1410. Further, since the actual-size display area offset 612 is specified as a position of the actual-size display area 640 relative to the reference coordinates of the print preview display area 630, if the value of the print preview display area offset 610 is updated, the value of the actual-size display area offset 612 is also changed. As a result, as shown in FIG. 11E, the display position of an image displayed in the actual-size preview area 1141 on the actual-size preview screen 1140 is changed. As shown in FIG. 14B, the third operation changes a relationship between the print preview display area 1421 and an actual-size display area 1422 in a display image 1420 to a relationship between the print preview display area 1431 and an actual-size display area 1432 in a display image 1430. Note that even when the third operation is performed, the position of the actual-size display area 1422, relative to the print preview display area 1421, is not changed. Therefore, the position of the actual-size display area 1403 in the mini map area 1402 is the same as the position of the actual-size display area 1413 in the mini map area 1412.

According to the above-described embodiment, the image in the mini map area 1142 (image for confirming the whole print result before printing) is displayed in a state superimposed on the image in the actual-size preview area 1141 (actual-size image). The image in the mini map area 1142 includes the actual-size display area 1143 (frame information) indicating the area displayed by the image of the actual-size preview area 1141. This enables, in a case where a print result is displayed on the display device 109 in its actual size, a user to grasp what part of the print result is displayed.

Further, in the above-described embodiment, the image in the mini map area 1142 is the preview image indicating a state in which an image has been printed on a designated sheet. The image in the actual preview area 1141 is an image formed by converting the print result included in the image in the mini map area 1142 to the actual size. This enables a user to grasp what part of the print result is displayed and the print result obtained by printing the image on a designated sheet, at the same time.

Further, in the above-described embodiment, the image in the actual-size preview area 1141 and the image in the mini map area 1142 are updated when a predetermined operation is received on the image in the actual-size preview area 1141. This makes it possible to reflect user's intention on the display of the image in the actual-size preview area 1141 and the image in the mini map area 1142.

Further, in the above-described embodiment, one of the predetermined operations is the first operation for reducing or enlarging the image in the actual-size preview area 1141. With this, it is possible to update the image in the actual-size preview area 1141 and the image in the mini map area 1142 to proper states according to the operation for reducing or enlarging the image in the actual-size preview area 1141, respectively.

Further, in the above-described embodiment, another of the predetermined operations is the second operation for changing the display range of the image in the actual-size preview area 1141. With this, it is possible to update the image in the actual-size preview area 1141 and the image in the mini map area 1142 to proper states according to the operation for changing the display range of the image in the actual-size preview area 1141, respectively.

Further, in the above-described embodiment, the other of the predetermined operations is the third operation for changing the printing range. With this, it is possible to update the image in the actual-size preview area 1141 and the image in the mini map area 1142 to proper states according to the operation for changing the printing range, respectively.

Next, the second embodiment of the present disclosure will be described. In the second embodiment, a description will be given of a configuration for performing the display of a preview screen of print data by using a remote UI. Here, the remote UI refers to a function of displaying a UI of the printing apparatus 300 on the display device 109 via the Web browser 206 of the information processing apparatus 100.

Note that in the second embodiment, the description of components having the same functions and operations as those of the components of the first embodiment is omitted, and only components having functions and operations different from those of the components of the first embodiment will be described below in detail.

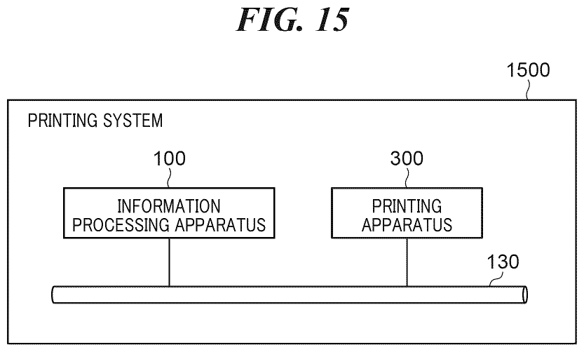

FIG. 15 is a diagram showing a configuration of a printing system 1500 in the second embodiment.

Referring to FIG. 15, the printing system 1500 is formed by the information processing apparatus 100, the printing apparatus 300, and the network 130. In the printing system 1500, the information processing apparatus 100 and the printing apparatus 300 are connected via the network 130.

The information processing apparatus 100 is an apparatus, such as a general PC, a smartphone, or a cloud server. The information processing apparatus 100 is capable of transmitting an instruction for printing print data to the printing apparatus 300 via the network 130. Further, the information processing apparatus 100 is capable of displaying the remote UI of the printing apparatus 300 on the display device 109 via the Web browser 206.

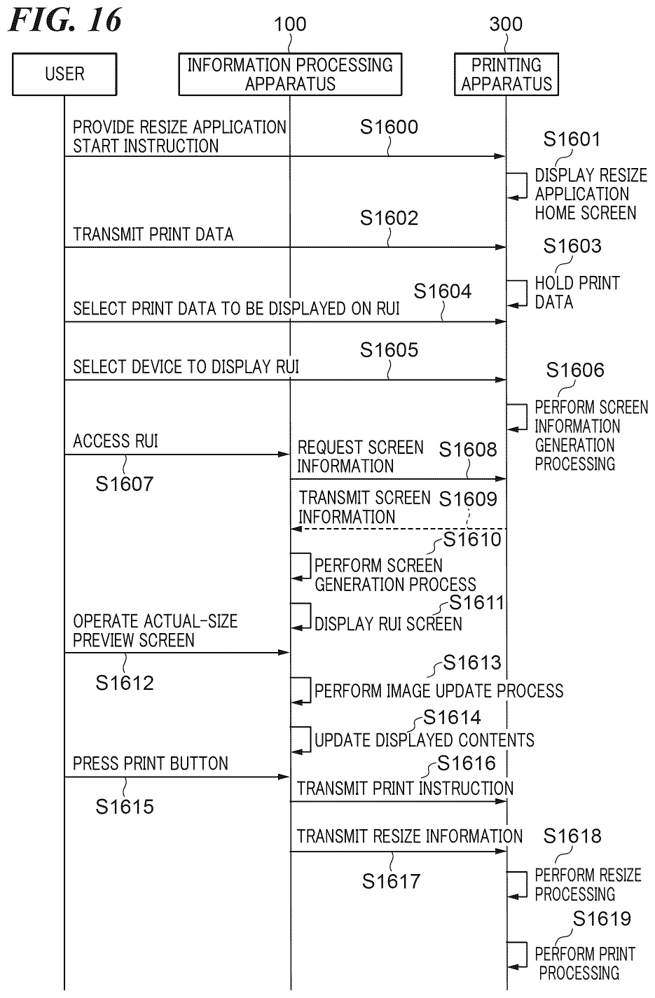

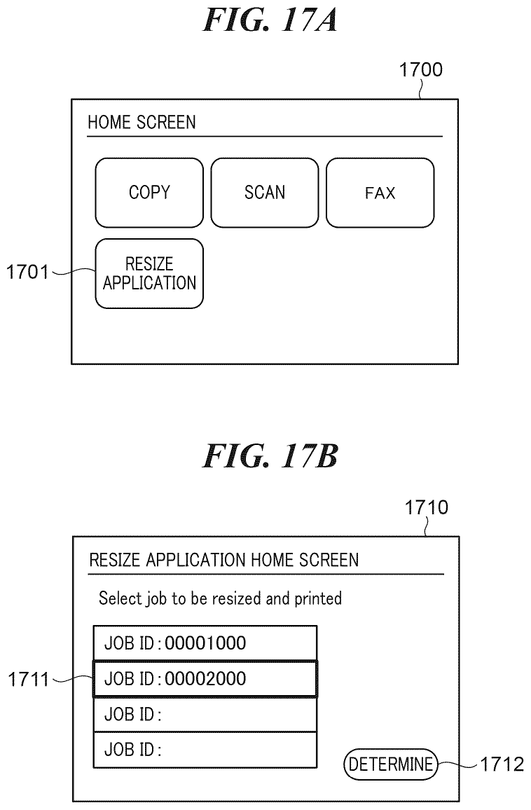

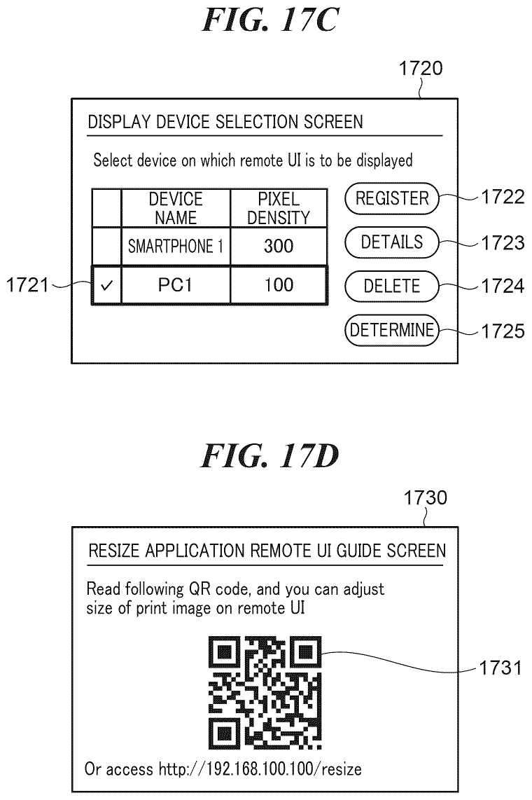

FIG. 16 is a sequence diagram of a print control process performed by the information processing apparatus 100 and the printing apparatus 300 in the second embodiment. Note that processing operations performed by the information processing apparatus 100 are realized by the CPU 102 executing a program loaded into the RAM 104. Processing operations performed by the printing apparatus 300 are realized by the CPU 302 executing a program loaded into the RAM 305. Note that it is assumed that a home screen 1700 shown in FIG. 17A is displayed on the display section 310 of the printing apparatus 300. On the home screen 1700, there are displayed icons enabling execution of the basic functions, such as copying and scanning, a resize application button 1701 for starting the resize application 410 for displaying a print image on the remote UI in its actual size.

Referring to FIG. 16, first, the user provides an instruction for starting the resize application 410 to the printing apparatus 300 (S1600). In the present embodiment, the user can provide the instruction for starting the resize application 410 by pressing the resize application button 1701 on the home screen 1700.

The printing apparatus 300 having received this start instruction starts the resize application 410. With this, at least processing operations in steps S1601, S1606, and S1609, described hereinafter, are executed by the resize application 410. A resize application home screen 1710 shown in FIG. 17B is displayed on the display section 310 (S1601). The resize application home screen 1710 is formed by a list 1711 of job IDs of print data held in the printing apparatus 300, a determine button 1712, and so forth.

Then, the user transmits print data e.g. from the PC or smartphone to the printing apparatus 300 (S1602). Note that as the method of inputting print data, any method can be used insofar as it is supported by the printing apparatus 300.

The printing apparatus 300 having received this print data temporarily holds the received print data e.g. in the storage 306 (S1603). Printing of the held print data is not immediately executed but executed at a time when a print instruction designating a job ID is received from the remote UI.

Then, the user selects print data desired to be displayed on the remote UI (denoted as “RUI” in FIG. 16) in its actual size, from the list 1711 on the resize application home screen 1710 (S1604). Note that in the present embodiment, when the user presses the determine button 1712 in a state in which one print data item is selected from the list 1711 on the resize application home screen 1710, the screen on the display section 310 is switched to a display device selection screen 1720 shown in FIG. 17C.

The display device selection screen 1720 is a screen for selecting a display device on which the remote UI is to be displayed. The display device selection screen 1720 is formed by a display device information list 1721, a registration button 1722, a detail button 1723, a delete button 1724, a determine button 1725, and so forth. In the display device information list 1721, a list of display device information registered in the printing apparatus 300 is displayed. When the user presses the registration button 1722, the printing apparatus 300 acquires information, such as the display pixel density 601, from the information processing apparatus 100 and registers the acquired information in the storage 306. When the user presses the detail button 1723, the printing apparatus 300 displays a list of a display device ID, a device name, a display pixel density 601, and so forth, as the detailed information of the display device information. When the user presses the delete button 1724, the printing apparatus 300 deletes display device information selected from the display device information list 1721.

Referring again to FIG. 16, the user selects a device on which the remote UI is to be displayed, from the display device information list 1721 on the display device selection screen 1720 (S1605). In the following description, it is assumed that the information processing apparatus 100 has been selected as the device on which the remote UI is to be displayed. When the user presses the determine button 1725 in a state in which the device on which the remote UI is to be displayed has been selected from the display device information list 1721, the present process proceeds to the step S1606.

In the step S1606, the printing apparatus 300 performs screen information generation processing. In the screen information generation processing, screen information to be displayed on the remote UI is generated. The screen information refers to information of the HTML format, for example. The screen information includes, for example, information for displaying a screen on the Web browser 206 and details of processing performed when the screen is operated (e.g. the actual-size preview screen information 600, details of the screen generation process in a step S1610, described hereinafter, and details of the screen update process in a step S1613, described hereinafter). Further, the printing apparatus 300 displays a remote UI guide screen 1730, shown in FIG. 17D, on the display section 310. On the remote UI guide screen 1730, a QR code (registered trademark) 1731 in which a uniform resource locator (URL) for accessing the actual-size preview screen 1800, described hereinafter with reference to FIG. 18, via the remote UI has been embedded is displayed. Note that the information to be displayed on the remote UI guide screen 1730 is not limited to the QR code, but any other two-dimensional information in which this URL has been embedded can be used, or the URL can be displayed in a text format.

Then, the user accesses the actual-size preview screen 1800 of the remote UI (S1607). In the present embodiment, the user can access the actual-size preview screen 1800 e.g. by inputting the URL for accessing the actual-size preview screen 1800 on the Web browser 206. Further, the user can also access the actual-size preview screen 1800 by causing the information processing apparatus 100, such as a smartphone, to read the QR code 1731 displayed on the remote UI guide screen 1730.

When the user accesses the actual-size preview screen 1800 on the Web browser 206, the Web browser 206 of the information processing apparatus 100 requests screen information to the printing apparatus 300 (S1608).

Upon receipt of the screen information request, the printing apparatus 300 transmits the screen information generated in the step S1606 to the Web browser 206 of the information processing apparatus 100 (S1609).

The Web browser 206 of the information processing apparatus 100 decrypts the screen information received from the printing apparatus 300 and performs the screen generation process described with reference to FIG. 7 (S1610). Then, the Web browser 206 of the information processing apparatus 100 displays the remote UI screen on the display device 109 as a Web page (S1611). By executing the steps S1607 to S1610, the actual-size preview screen 1800 shown in FIG. 18 is displayed on the display device 109 of the information processing apparatus 100 via the remote UI.

The actual-size preview screen 1800 is comprised of a resize magnification-changing area 1801, an actual-size display range-changing object 1802, a printing range-changing object 1803, an actual-size preview area 1804, a mini map area 1805, a setting button 1808, a print button 1809, and so forth.

The resize magnification-changing area 1801 includes a slider and a button, or the like, for changing the resize magnification 607. The user can reduce or enlarge an image displayed in the actual-size preview area 1804 by operating the resize magnification-changing area 1801. That is, the operation of the resize magnification-changing area 1801 corresponds to the first operation.

The actual-size display range-changing object 1802 includes a button or the like, for changing the actual-size display area offset 612. The user can change the display range of the image displayed in the actual-size preview area 1804 by operating the actual-size display range-changing object 1802. That is, the operation of the actual-size display range-changing object 1802 corresponds to the second operation.

The printing range-changing object 1803 includes a button or the like, for changing the print preview display area offset 610. The user can change the display range of the image displayed in a print preview display area 1807 in the mini map area 1805, i.e. the printing range, by operating the printing range-changing object 1803. That is, the operation of the printing range-changing object 1803 corresponds to the third operation.

In the actual-size preview area 1804, an actual-size image of a print result to be obtained when a print image is printed on a sheet by the printing apparatus 300 is displayed. By confirming the image in the actual-size preview area 1804, the user can perform the operation for changing the size of the print image while intuitively confirming the size of the print result before printing.

The mini map area 1805 is formed by an actual-size display area 1806 and the print preview display area 1807 and is drawn on the actual-size preview screen 1800 by executing the processing in the step S1610. When the user presses the setting button 1808, the user can change the print settings including a monochrome/color setting and an image correction setting. When the user presses the print button 1809, a print instruction and the resize information are transmitted from the information processing apparatus 100 to the printing apparatus 300, and the print processing is executed by the printing apparatus 300 after execution of resize processing.

Referring again to FIG. 16, when the user operates the actual-size preview screen 1800 (S1612), the information processing apparatus 100 performs the screen update process described with reference to FIG. 10 (S1613). In the screen update process, the actual-size preview screen information 600 is updated according to the operation performed on the actual-size preview screen 1800.

Then, the information processing apparatus 100 updates the contents displayed on the actual-size preview screen 1800 based on the updated actual-size preview screen information 600 (S1614).

Then, when the user presses the print button 1809 (S1615), the information processing apparatus 100 transmits a print instruction and the resize information to the printing apparatus 300 (S1616 and S1617). The resize information is information including part of the actual-size preview screen information 600 necessary for the resize processing in a step S1618, described hereinafter, such as the resize magnification 607 and the print preview display area offset 610. Note that the steps S1616 and S1617 can be executed in inverse order, and further, these processing operations can be executed in parallel.

Then, upon receipt of the print instruction and the resize information, the printing apparatus 300 executes the resize processing on the print image of the corresponding job based on the resize magnification 607 included in the resize information (S1618).

Then, the printing apparatus 300 prints the print image on which the resize processing has been performed (S1619). By printing the print image on which the resize processing has been performed based on the resize magnification 607, the print image having a size equal to the size displayed in the actual-size preview area 1804 of the display device 109 is printed. After that, the present process is terminated.

Thus, also in the configuration in which the display of the preview screen of print data is performed by the remote UI, it is possible to obtain the same advantageous effects as provided by the above-described embodiment.

Further, although in the above-described configuration of the second embodiment, the screen generation process in the step S1610 and the screen update process in the step S1613 are performed by the information processing apparatus 100, this is not limitative. For example, the printing apparatus 300 can execute the screen generation process in the step S1610 and the screen update process in the step S1613 and transmit the results the processing to the information processing apparatus 100.

Next, a third embodiment of the present disclosure will be described.

In the above-described first and second embodiments, the description has been given of the method of displaying the print result on the actual-size preview screen 1140 and the actual-size preview screen 1800 in its actual size, respectively, and the method of displaying the image in the mini map area 1142 and the image in the mini map area 1805, respectively.

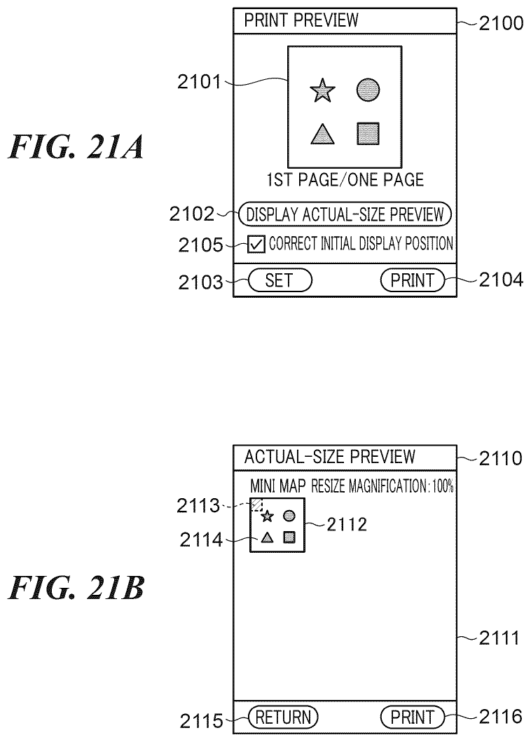

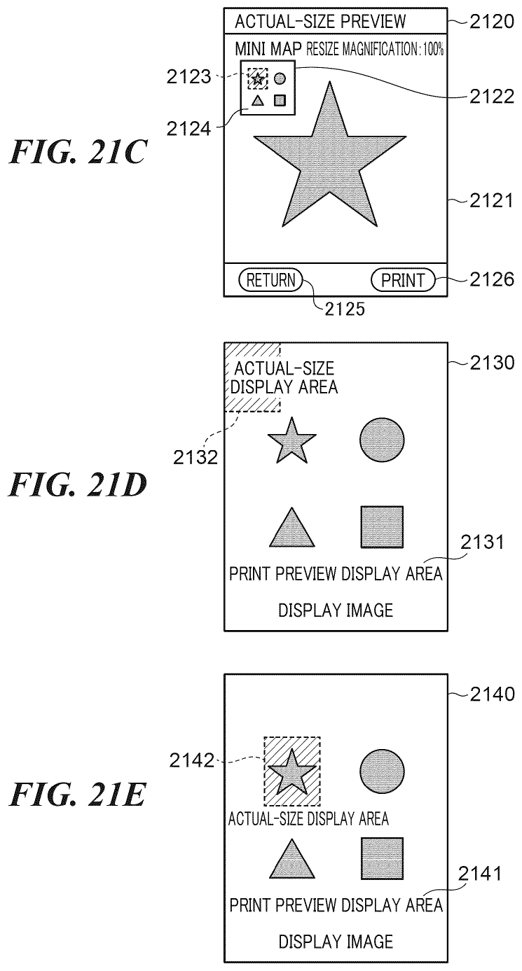

Here, a case is considered where a print result is displayed on the display device 109 (such as a smartphone) having the display screen size 602 smaller than the display image size 606, in its actual size. In such a case, the range of the actual-size display area 640 is very small relative to the display image 620, and hence only part of the display image 620 is displayed in the actual-size preview area 1141. For example, in a case shown in FIG. 21D, when the actual-size preview screen 1140 is displayed in its initial state, an actual-size display area 2132 includes only a margin area on upper left part of a display image 2130. Although an image in an area other than the blank area can be confirmed when the user moves the actual-size display area 2132 by performing the second operation, described in the first embodiment, the user is required to perform this operation whenever the actual-size preview screen is initially displayed, and this is inconvenient for the user.

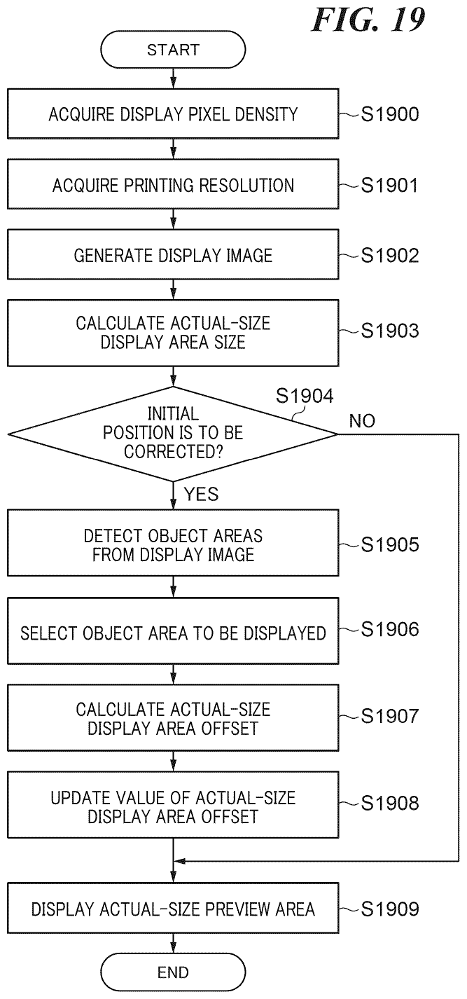

To solve this inconvenience, in the third embodiment, a description will be given of a method of correcting the initial display position of the actual-size display area 640 such that an object area (area other than the margin area) of the display image 620 is displayed in the actual-size preview area when the actual-size preview screen is displayed in its initial state in the actual-size preview area-drawing process. Note that in the third embodiment, the actual-size preview area-drawing process is different from the contents described with reference to FIG. 8. Therefore, the actual-size preview area-drawing process in the third embodiment will be described with reference to FIG. 19.

FIG. 19 is a flowchart of the actual-size preview area-drawing process performed by the information processing apparatus 100 according to the third embodiment. Note that the actual-size preview area-drawing process in FIG. 19 is a process similar to the actual-size preview area-drawing process described with reference to FIG. 8, and hence the following description will be given mainly of details different from those of the actual-size preview area-drawing process in FIG. 8. Similar to the actual-size preview area-drawing process described with reference to FIG. 8, the actual-size preview area-drawing process in FIG. 19 is also realized by the CPU 102 executing a program loaded into the RAM 104.

Referring to FIG. 19, first, the CPU 102 acquires the value of the display pixel density 601 and the value of the printing resolution 603 of the display device 109 from the actual-size preview screen information 600 (S1900 and S1901).

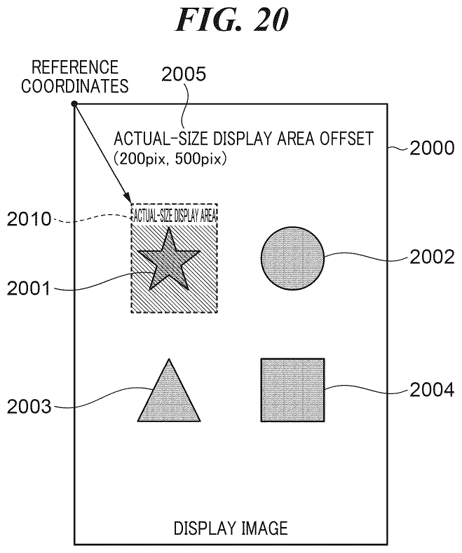

Then, the CPU 102 generates a display image 2000, shown in FIG. 20, for displaying a print image in the actual-size preview area 1141 in its actual size (S1902). The display image 2000 is an image converted in image size in accordance with the display pixel density 601 so as to display the print image generated with reference to the printing resolution 603 on the display device 109.

Then, the CPU 102 calculates the actual-size display area size 611 when displaying the display image 2000 in its actual size on the display device 109 (S1903).

Then, the CPU 102 determines whether or not it is required to correct the initial position (S1904). In the present embodiment, the user can set whether or not it is required to correct the initial position, by using an initial position correction check box 2105 or the like on a print preview screen 2100 shown in FIG. 21A. If it is determined that the initial position correction is not to be performed, the present process proceeds to a step S1909, described hereinafter. If it is determined that the initial position correction is to be performed, the present process proceeds to a step S1905.

In the step S1905, the CPU 102 detects object areas of the display image 2000. The object areas can be detected by using a method of comparing whether or not a pixel value of the display image 2000 is equal to or larger than a threshold value. With this, the object areas other than the margin area are detected from the display image 2000. Alternatively, the object areas other than the margin area can be detected by using an image recognition method using e.g. the artificial intelligence. By executing the step S1905, for example, an object area 2001, an object area 2002, an object area 2003, and an object area 2004 are detected from the display image 2000 as areas other than the margin area.

Then, the CPU 102 selects an object area to be displayed (S1906). The object area to be displayed is an object area to be displayed in the actual-size preview area when the actual-size preview screen is displayed in its initial state and can be selected by desired selection processing, such as processing for selecting an object area closest to the reference coordinates. For example, in a case where an object area closest to the reference coordinates is selected, the CPU 102 selects the object area 2001 closest to the reference coordinates 608 as the object area to be displayed.

Then, the CPU 102 calculates a value of an actual-size display area offset 2005, appearing in FIG. 20, for displaying the object area selected in the step S1906, in the actual-size preview area (S1907). The offset value can be calculated by using a desired calculation method insofar as the object area is included in an actual-size display area 2010. For example, in a case where the object area 2001 is selected in the step S1906, the value of the actual-size display area offset 2005 is calculated such that the object area 2001 is included in the actual-size display area 2010. Note that the value of the actual-size display area offset 2005 is not limited to such a value. For example, a value with which the center coordinates of the object area 2001 are caused to be located in the center of the actual-size display area 2010 can be set as the value of the actual-size display area offset 2005. Further, the value of the actual-size display area offset 2005 can be calculated such that a vertex as a reference of a rectangular area including the object area 2001 (e.g. an upper left vertex) overlaps a vertex as a reference of the actual-size display area 2010 (e.g. an upper left vertex).

Then, the CPU 102 updates the value of the actual-size display area offset 2005 to the value calculated in the step S1907 (S1908).

Then, the CPU 102 displays the image of the actual-size display area 2010, which is determined by the actual-size display area size 611 and the actual-size display area offset 2005, of the display image 2000 generated in the step S1902, in the actual-size preview area (S1909). After that, the present process is terminated.

FIGS. 21A to 21E are diagrams each showing an example of a screen displayed on the display device 109 of the information processing apparatus 100 in the third embodiment.

FIG. 21A shows the print preview screen 2100 of the print application 203. The print preview screen 2100 is comprised of a print preview area 2101, an actual-size preview display button 2102, a setting button 2103, a print button 2104, and the initial position correction check box 2105.

In the print preview area 2101, the whole print image laid out for printing is displayed. When the user presses the setting button 2103, the user can change the print settings including a monochrome/color setting and an image correction setting. When the user presses the print button 2104, the CPU 102 transmits a print instruction to the printing apparatus 300, and the print processing is executed by the printing apparatus 300. By setting the initial position correction check box 2105, whether or not to execute initial position correction can be switched in the actual-size preview area-drawing process. Further, when the user presses the actual-size preview display button 2102, the screen shifts to the actual-size preview screen.

FIG. 21B is a diagram showing an actual-size preview screen 2110 of the print application 203 in a case where the initial position correction check box 2105 is set to be disabled. Further, FIG. 21D is a diagram showing the display image 2130 used for the display of this actual-size preview screen 2110. Note that this is an example in a case where the resize magnification is set to 100%, and hence in FIG. 21D, the size of the display image 2130 and the size of a print preview display area 2131 are equal to each other.

The actual-size preview screen 2110 is formed by an actual-size preview area 2111, a mini map area 2112, an actual-size display area 2113, a print preview display area 2114, a return button 2115, a print button 2116, and so forth.

In the actual-size preview area 2111, an actual-size image of a print result to be obtained when a print image is printed on a sheet by the printing apparatus 300 is displayed. In a case where the initial position correction check box 2105 is set to be disabled, only margin area is sometimes displayed in the actual-size preview area 2111 depending on a condition, such as a condition that the display screen size 602 is smaller than the size of the display image 2000. In the illustrated examples in FIGS. 21B and 21D, only the image in the actual-size display area 2132 in the display image 2130, i.e. only the image in the margin area is displayed on the actual-size preview screen 2111.

Further, the mini map area 2112 is formed by the actual-size display area 2113 and the print preview display area 2114 and is drawn on the actual-size preview screen 2110.

Further, when the user presses the return button 2115, the screen shifts to the print preview screen 2100, and when the user presses the print button 2116, the CPU 102 transmits a print instruction to the printing apparatus 300, and the print processing is executed by the printing apparatus 300.

FIG. 21C is a diagram showing an actual-size preview screen 2120 of the print application 203 in a case where the initial position correction check box 2105 is set to be enabled. Further, FIG. 21E is a diagram showing a display image 2140 used for the display of this actual-size preview screen 2120. Note that this is an example in a case where the resize magnification is set to 100%, and hence in FIG. 21E, the size of the display image 2140 and the size of a print preview display area 2141 are equal to each other.

The actual-size preview screen 2120 is formed by an actual-size preview area 2121, a mini map area 2122, an actual-size display area 2123, a print preview display area 2124, a return button 2125, a print button 2126, and so forth.

In the actual-size preview area 2121, an actual-size image of a print result to be obtained when a print image is printed on a sheet by the printing apparatus 300 is displayed. In a case where the initial position correction check box 2105 is set to be enabled, the CPU 102 performs initial position correction. This causes the value of the actual-size display area offset 612 to be updated such that the object area selected in the step S1906 is displayed, and for example, an image of an actual-size display area 2142 in the display image 2140 is displayed in the actual size preview area 2121. In the illustrated examples in FIGS. 21C and 21E, the actual-size display area 2142 in the display image 2140 is set such that the actual-size display area 2142 include a star-shaped object area, as a result of the initial position correction.

Further, the mini map area 2122 is formed by the actual-size display area 2123 and the print preview display area 2124 and is drawn on the actual-size preview screen 2120.

When the user presses the return button 2125, the screen shifts to the print preview screen 2100. When the user presses the print button 2126, the CPU 102 transmits a print instruction to the printing apparatus 300, and the print processing is executed by the printing apparatus 300.

In the above-described embodiment, when the actual-size preview screen is displayed in its initial state, the initial position correction for displaying the object area (area other than the margin area) of the display image, in the actual-size preview area, is performed. This makes it possible to improve the convenience of the actual-size preview screen without forcing a user to perform the second operation which is unnecessary.

Further, in the above-described embodiment, whether or not to execute the initial position correction is controlled based on a setting made by a user in the initial position correction check box 2105. This makes it possible to reflect user's intention on execution of the initial position correction.

Note that in the above-described embodiment, the display position of the mini map area on the actual-size preview screen can be made changeable according to a user's operation. This makes it possible to move the mini map area to a position intended by the user, and to avoid a situation that the image of the actual-size preview area is made invisible by being hidden by the image of the mini map area.

Note that the printing apparatus 300 as the image forming apparatus includes functions of the information processing apparatus 100 related to the present disclosure, and the program for realizing the functions can be installed in the printing apparatus 300.

According to the present disclosure, in a case where a print result is displayed on a display device in its actual size, a user is enabled to grasp what part of the print result is displayed.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-144217 filed Aug. 26, 2024, which is hereby incorporated by reference herein in its entirety.

What is claimed is:

1. A non-transitory computer-readable storage medium storing a program for causing a computer to execute a method of causing a printing apparatus to execute printing,
wherein the method comprises:
causing an apparatus in which the program has been installed to display an actual-size image for confirming a print result in its actual size, before printing; and
causing the apparatus in which the program has been installed to display a whole image for confirming a whole print result in a state superimposed on the actual-size image, before printing,
wherein in the whole image, frame information indicating an area displayed by the actual-size image is included.

2. The storage medium according to claim 1, wherein the whole image is a preview image indicating a state in which an image is printed on a designated sheet, and
wherein the actual-size image is an image generated by converting a size of a print result included in the whole image to the actual size.

3. The storage medium according to claim 1, wherein the method further comprises causing the apparatus in which the program has been installed to update the actual-size image and the whole image according to reception of a predetermined operation performed on the actual-size image.

4. The storage medium according to claim 3, wherein the predetermined operation is an operation for reducing or enlarging the actual-size image.

5. The storage medium according to claim 3, wherein the predetermined operation is an operation for changing a display range of the actual-size image.

6. The storage medium according to claim 3, wherein the predetermined operation is an operation for changing a printing range.

7. The storage medium according to claim 1, wherein the method further comprises causing the apparatus in which the program has been installed to perform correction processing for displaying an actual-size image including at least an object area in the whole image when displaying the actual-size image according to an instruction provided by a user.

8. The storage medium according to claim 7, wherein whether or not to execute the correction processing is controlled based on a setting made by the user.

9. The storage medium according to claim 1, wherein the method further comprises causing the apparatus in which the program has been installed to change a display position of the whole image according to an operation received from a user.

10. A method of controlling an apparatus in which a program for instructing a printing apparatus to execute printing has been installed, comprising:
causing the apparatus in which the program has been installed to display an actual-size image for confirming a print result in its actual size, before printing; and
causing the apparatus in which the program has been installed to display a whole image for confirming a whole print result in a state superimposed on the actual-size image, before printing,
wherein in the whole image, frame information indicating an area displayed by the actual-size image is included.

11. An information processing apparatus having a program installed therein for causing a computer to execute a method of causing a printing apparatus to execute printing,
wherein the method comprises:
causing the information processing apparatus to display an actual-size image for confirming a print result in its actual size, before printing; and
causing the information processing apparatus to display a whole image for confirming a whole print result in a state superimposed on the actual-size image, before printing,
wherein in the whole image, frame information indicating an area displayed by the actual-size image is included.

12. An image forming apparatus having a program installed therein for causing a computer to execute a method of causing the image forming apparatus to execute printing,
wherein the method comprises:
causing the image forming apparatus to display an actual-size image for confirming a print result in its actual size, before printing; and
causing the image forming apparatus to display a whole image for confirming a whole print result in a state superimposed on the actual-size image, before printing,
wherein in the whole image, frame information indicating an area displayed by the actual-size image is included.
